(19) United States
(12) Patent Application Publication
(10) Pub. No.: US 2025/0329850 A1
(43) Pub. Date: Oct. 23, 2025

(54) CONDUCTIVE MODULE

(71) Applicants: YAZAKI CORPORATION, Tokyo (JP); TOYOTA JIDOSHA KABUSHIKI KAISHA, Toyota-shi (JP)

(72) Inventors: Ryota Ando, Makinohara-shi (JP); Yuki Ohira, Nisshin-shi (JP)

(21) Appl. No.: 19/098,999

(22) Filed: Apr. 3, 2025

(30) Foreign Application Priority Data
Apr. 18, 2024 (JP) 2024-067250

(51) Int. Cl. H01M 50/262; H01M 50/209; H01M 50/271; H01M 50/507; H01M 50/519

(52) U.S. Cl. CPC H01M 50/262; H01M 50/209; H01M 50/271; H01M 50/507; H01M 50/519; H01M 2220/20

(57) ABSTRACT

A plurality of bus bars; a circuit conductor component that includes a circuit conductor; a housing member that houses the bus bar and the circuit conductor component; and a cover member that is assembled to the housing member are provided, and the circuit conductor component includes a main line portion in which the circuit conductor is wired and is housed at a prescribed position in the housing member, and a branch portion that branches the circuit conductor from the main line portion and is bent and routed in a prescribed shape within an elastic range between the main line portion at the prescribed position and the bus bar, and the housing member is provided with a main line locking portion that locks the main line portion at the prescribed position.

### CROSS-REFERENCE TO RELATED APPLICATION(S)

The present application claims priority to and incorporates by reference the entire contents of Japanese Patent Application No. 2024-067250 filed in Japan on Apr. 18, 2024.

### BACKGROUND OF THE INVENTION

### 1. Field of the Invention

The present invention relates to a conductive module.

### 2. Description of the Related Art

The conductive module electrically connects a plurality of battery cells using a plurality of bus bars in a battery module in which the plurality of battery cells is arranged. Then, the conductive module electrically connects each bus bar to a battery monitoring unit via a flat circuit conductor component provided with a circuit conductor for each bus bar and having flexibility. The circuit conductor component is, for example, a flexible printed circuit board including a sheet-shaped insulating layer and a conductor layer provided with a plurality of circuit conductors, and is housed in a housing member together with the bus bar and covered with a cover member. The circuit conductor component includes a main line portion in which a circuit conductor for each bus bar is wired, and a branch portion obtained by branching the circuit conductor for each bus bar from the main line portion, and the circuit conductor of the branch portion is electrically connected to the bus bar. This type of conductive module is disclosed in, for example, JP 2022-173 610 A. In the conductive module of JP 2022-173 610 A, the circuit conductor of the branch portion is electrically connected to the bus bar via a terminal fitting. In the conductive module of JP 2022-173 610 A, the branch portion is bent and routed within an elastic range between the main line portion and the terminal fitting.

Incidentally, in the conductive module, for example, an end of the branch portion or the terminal fitting fixed to the end of the branch portion is fixed to the bus bar positioned in the housing member, and then the branch portion is bent into a prescribed shape, and the cover member is assembled to the housing member. Therefore, in the circuit conductor component, a reaction force caused by bending of the branch portion acts on the bus bar or the terminal fitting, but the reaction force is returned from the bus bar or the terminal fitting to the branch portion, and the main line portion rises while the branch portion returns to the pre-bending shape. For this reason, the conventional conductive module may deteriorate assembling workability of the cover member.

### SUMMARY OF THE INVENTION

Therefore, an object of the present invention is to provide a conductive module capable of improving assembling workability of a cover member.

In order to achieve the above mentioned object, a conductive module according to one aspect of the present invention includes a plurality of bus bars that electrically connects a plurality of battery cells in a battery module; a circuit conductor component that includes a circuit conductor for each of the bus bars that electrically connects the bus bar to a battery monitoring unit, the circuit conductor component being formed flat with flexibility; a housing member that houses the bus bar and the circuit conductor component through an opening; and a cover member that is assembled to the housing member and closes the opening, wherein the circuit conductor component includes a main line portion in which the circuit conductor for each of the bus bars is wired and that is housed at a prescribed position in the housing member, and a branch portion that is obtained by branching the circuit conductor for each of the bus bars from the main line portion and is bent and routed in a prescribed shape within an elastic range between the main line portion at the prescribed position and the bus bar, and the housing member is provided with a main line locking portion that locks the main line portion at the prescribed position in a state where the branch portion is bent into the prescribed shape.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is an exploded perspective view illustrating the conductive module according to the embodiment;

FIG. 3 is a plan view extracting a part of the conductive module from which a cover member and a circuit cover member are removed, and illustrates a state in which a main line portion is locked at a prescribed position by a main line locking portion;

FIG. 4 is a partially enlarged view taken along line X1-X1 in FIG. 3;

FIG. 5 is a partially enlarged view taken along line X2-X2 in FIG. 3;

FIG. 6 is a schematic view illustrating a battery module together with bus bars;

FIG. 7 is a plan view extracting a part of the conductive module from which the cover member and the circuit cover member are removed, and illustrates a state in which the main line locking portion is located at a non-locking position;

FIG. 8 is a partially enlarged view taken along line X2-X2 in FIG. 7;

FIG. 9 is a plan view extracting a part of the conductive module from which the cover member is removed; and

FIG. 10 is a partially enlarged view taken along line X3-X3 in FIG. 9.

### DETAILED DESCRIPTION OF THE PREFERRED EMBODIMENTS

Hereinafter, an embodiment of the conductive module according to the present invention will be described in detail with reference to the drawings. Note that this invention is not limited by this embodiment.

### Embodiment

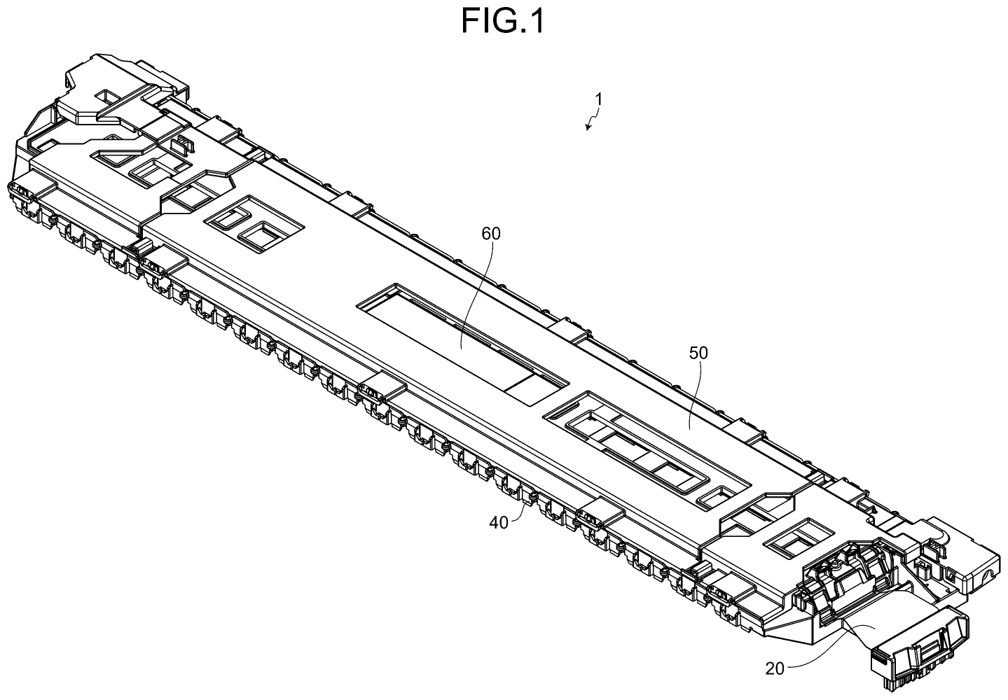

One embodiment of the conductive module according to the present invention will be described with reference to FIGS. 1 to 10.

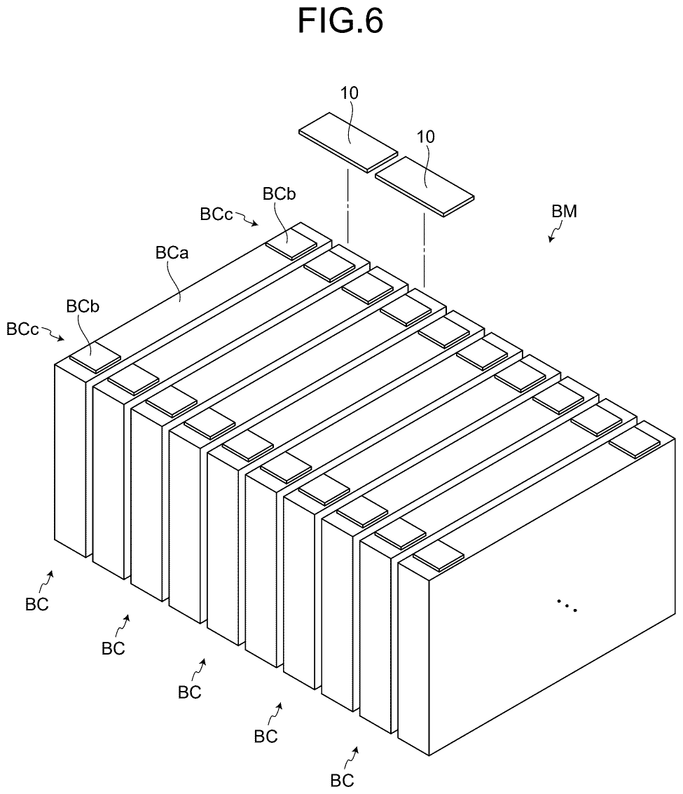

Reference numeral 1 in FIGS. 1 to 5 denotes a conductive module of the present embodiment. The conductive module 1 is assembled to a battery module BM (FIG. 6) in which a plurality of battery cells BC is arranged (e.g., arranged in a row), and electrically connects the plurality of battery cells BC in the battery module BM. In addition, the conductive module 1 electrically connects the battery module BM to a battery monitoring unit (illustration omitted) to cause the battery monitoring unit to monitor the battery state of the battery cells BC. The conductive module 1 constitutes a battery pack together with the battery module BM. The battery pack is mounted on, for example, a vehicle (battery electric vehicle (BEV), hybrid electric vehicle (HEV), or the like) including a rotary machine as a drive source, and is used for power supply to the rotary machine.

The battery cell BC includes a cell body BCa and positive and negative electrode terminals BCb (FIG. 6). In the battery cell BC illustrated here, the cell body BCa is formed in a rectangular parallelepiped shape having six outer wall surfaces. Then, in the plurality of battery cells BC constituting the battery module BM, the cell bodies BCa adjacent to each other in the arrangement direction are disposed with one outer wall surface facing each other. The battery module BM includes one electrode terminal group BCc in which electrode terminals BCb of the battery cells BC on one side are arranged along the arrangement direction, and the other electrode terminal group BCc in which electrode terminals BCb of the battery cells BC on the other side are arranged along the arrangement direction (FIG. 6).

Hereinafter, when the term “arrangement direction” is described without particular reference, it refers to the arrangement direction of the plurality of battery cells BC or the arrangement direction of the plurality of electrode terminals BCb in the electrode terminal group BCc.

In this example, each battery cell BC includes positive and negative electrode terminals BCb on one of the six outer wall surfaces of the cell body BCa (FIG. 6). Therefore, in the battery module BM, two electrode terminal groups BCc are provided on one plane (FIG. 6).

In addition, the electrode terminals BCb illustrated here are formed in a flat plate shape, and physically and electrically connect bus bars 10 to be described below by welding or the like (FIG. 6). However, the electrode terminals BCb may be formed in a pole shape having a male screw portion. In this case, the bus bar 10 is fixedly screwed to the electrode terminal BCb by screwing a female screw member to the male screw portion of the electrode terminal BCb.

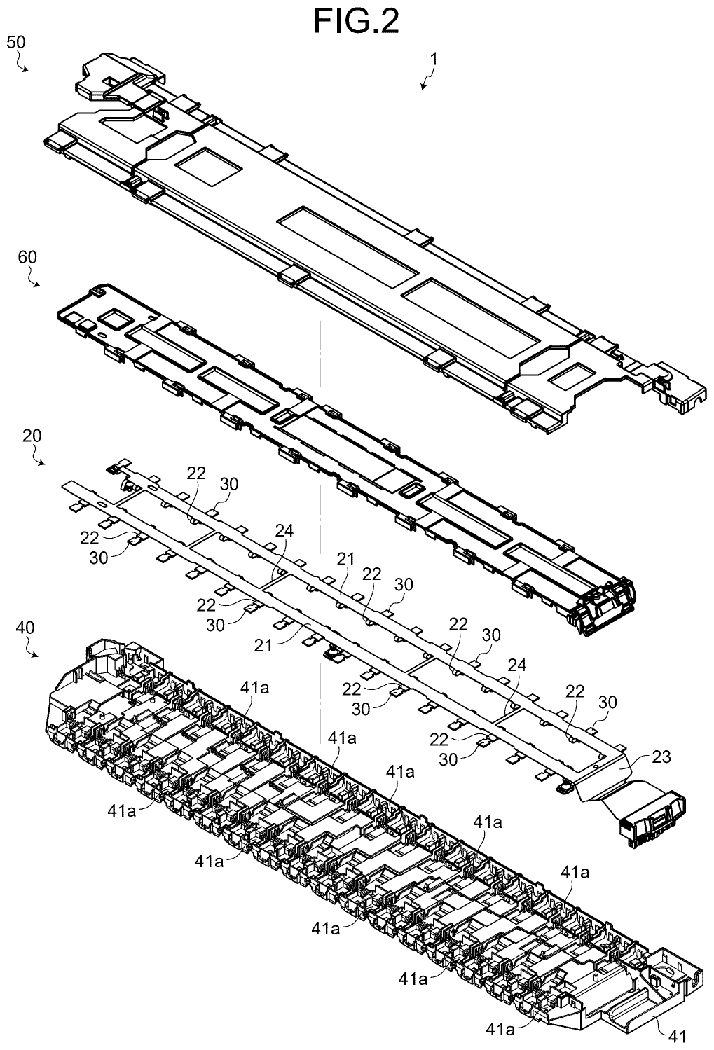

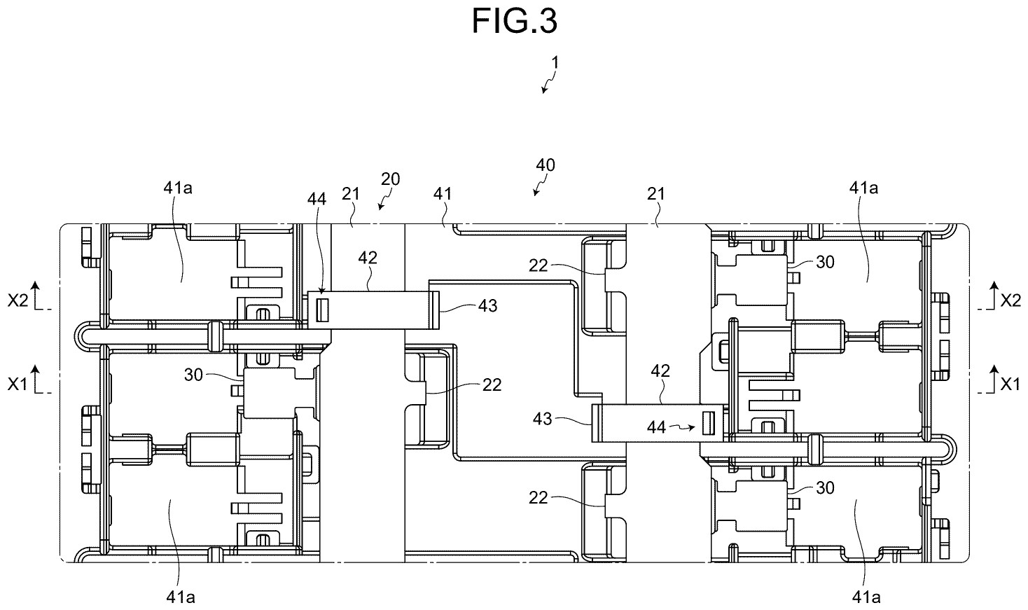

The conductive module 1 includes a plurality of bus bars 10 electrically connecting the plurality of battery cells BC of the battery module BM (FIG. 6). Then, the conductive module 1 includes a circuit conductor component 20 that includes a circuit conductor for each bus bar 10 that electrically connects the bus bar 10 to the battery monitoring unit, and is formed flat with flexibility (FIGS. 1 to 5). The conductive module 1 of the present embodiment further includes a terminal fitting 30 for each bus bar 10 that electrically connects the circuit conductor to the bus bar 10, which is a connection target (FIGS. 2 and 3). The conductive module 1 includes a housing member 40 that houses the bus bar 10 and the circuit conductor component 20 through an opening, and a cover member 50 that is assembled to the housing member 40 and closes the opening (FIGS. 1 and 2). Furthermore, the conductive module 1 includes a circuit cover member 60 that is assembled to the housing member 40, is interposed between the circuit conductor component 20 and the cover member 50, and covers the circuit conductor component 20 (FIG. 2). Here, for example, the terminal fitting 30 for each bus bar 10 is attached in advance to the circuit conductor component 20, and the circuit conductor component 20 with the terminal fittings 30 is housed in the housing member 40.

The bus bar 10 and the terminal fitting 30 are molded of a conductive material such as metal. The circuit conductor component 20 is made of a conductive material such as metal and an insulating material such as synthetic resin. The housing member 40, the cover member 50, and the circuit cover member 60 are molded of an insulating material such as synthetic resin.

The bus bar 10 is a plate-shaped conductive component made of metal, and is press-molded using, for example, a metal plate as a base material. The bus bar 10 illustrated here is molded in a rectangular flat plate shape.

The conductive module 1 includes, as the bus bars 10, for example, one that is physically and electrically connected to the adjacent electrode terminals BCb of a pair of battery cells BC of the battery module BM, one that is physically and electrically connected to the electrode terminal BCb serving as the total negative electrode of the battery module BM, and one that is physically and electrically connected to the electrode terminal BCb serving as the total positive electrode of the battery module BM.

As the circuit conductor component 20, for example, a flexible printed circuit board (FPC) on which a conductor pattern as a circuit conductor is formed for each bus bar 10 is used.

The circuit conductor component 20 includes a main line portion 21 in which the circuit conductor for each bus bar 10 is wired and that is housed at a prescribed position in the housing member 40, and a branch portion 22 that is obtained by branching the circuit conductor for each bus bar 10 from the main line portion 21 and is bent and routed in a prescribed shape within an elastic range between the main line portion 21 at the prescribed position and the bus bar 10 (FIGS. 2 to 4).

The main line portions 21 extend in the arrangement direction and are disposed side by side in a direction orthogonal to the arrangement direction with respect to the bus bars 10, which are connection targets. In the main line portion 21, the circuit conductor for each bus bar 10 is wired along the arrangement direction. The branch portion 22 is branched from the main line portion 21 together with the circuit conductor for the bus bar 10, which is a connection target. In the branch portion 22, the circuit conductor is wired up to a distal end portion.

The main line portion 21 illustrated here is formed in a rectangular sheet shape in which one side portion along the arrangement direction is placed on the bus bar 10 side, which is a connection target, and the branch portion 22 is branched for each bus bar 10 from the other side portion side along the arrangement direction as a branch start point. The branch portion 22 illustrated here is formed in a rectangular sheet shape.

When viewed from the branch portion 22 side, the main line portion 21 can be said to be a cantilever having the other side portion (that is, the branch start point side) from which the branch portion 22 is branched as a fixed end. In addition, when viewed from the main line portion 21 side, the branch portion 22 can be said to be a cantilever having the branch start point side as a fixed end.

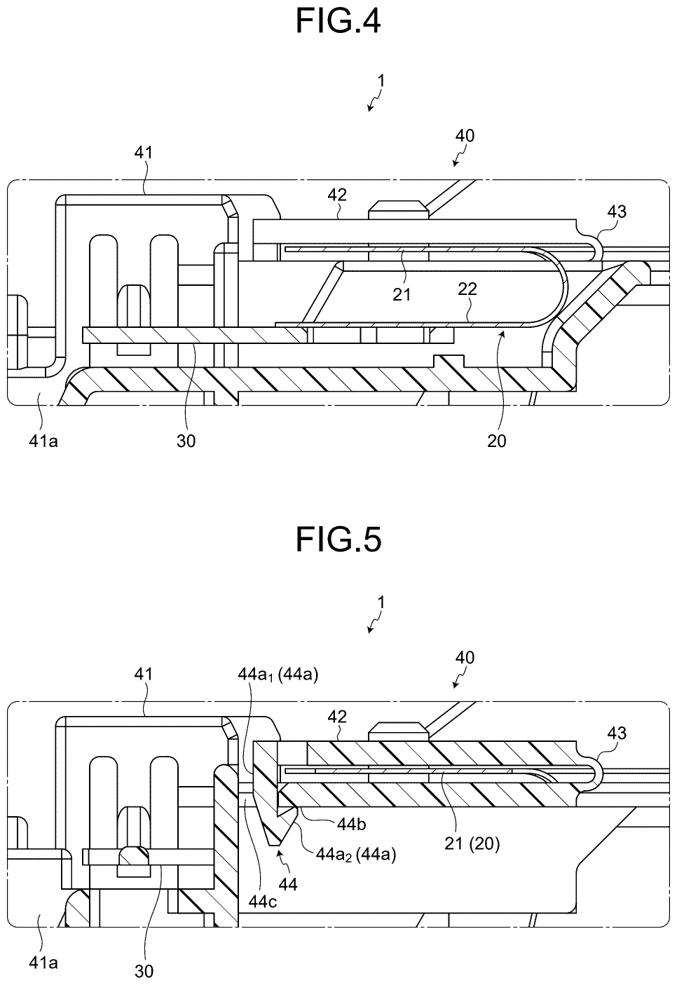

The branch portion 22 is bent in a U shape from the branch start point side for the branch portion 22 of the main line portion 21 so as to crawl between the main line portion 21 and the bottom portion of the housing member 40 (FIG. 4). That is, the branch portion 22 branches from the other side portion of the main line portion 21 in the housing member 40, passes between the main line portion 21 and the bottom portion of the housing member 40, and is folded back to the one side portion side of the main line portion 21.

The terminal fitting 30 for the bus bar 10, which is a connection target, is attached to the distal end portion of the branch portion 22 (FIG. 4). The terminal fitting 30 is a plate-shaped conductive component made of metal, and is press-molded using, for example, a metal plate as a base material. The terminal fitting 30 is attached to the distal end portion of the branch portion 22 for each bus bar 10 and is physically and electrically connected to the circuit conductor of the branch portion 22. The terminal fitting 30 is physically and electrically connected to the circuit conductor of the branch portion 22 by, for example, welding.

The distal end portion of the branch portion 22 illustrated here is disposed between the main line portion 21 and the bottom portion of the housing member 40 in the housing member 40 (FIG. 4). In addition, the terminal fitting 30 illustrated here is disposed on the bottom portion side of the housing member 40 with respect to the distal end portion of the branch portion 22 in the housing member 40 (FIG. 4). Therefore, the terminal fitting 30 is attached to the distal end portion of the branch portion 22 between the main line portion 21 and the bottom portion of the housing member 40. The terminal fitting 30 illustrated here is attached in advance to the distal end portion of the branch portion 22.

Note that the terminal fitting 30 extends from the position of attachment to the distal end portion of the branch portion 22 to the bus bar 10 side, which is a connection target, in the housing member 40, and is physically and electrically connected to the bus bar 10 at the end of the extension. The terminal fitting 30 is placed on the bus bar 10 in the housing member 40, and is physically and electrically connected to the bus bar 10 by welding or the like, for example.

The circuit conductor component 20 illustrated here includes an assembly of the main line portion 21 and the branch portion 22 for each bus bar for each electrode terminal group BCc (FIGS. 2 and 3).

The circuit conductor component 20 includes a circuit collection portion 23 in which the ends in the arrangement direction of the main line portion 21 of one electrode terminal group BCc and the main line portion 21 of the other electrode terminal group BCc are coupled to each other, and the plurality of circuit conductors of both main line portions 21 are collected at one place (FIG. 2). In the circuit conductor component 20, the circuit collection portion 23 is electrically connected to the battery monitoring unit.

In addition, in the circuit conductor component 20, the main line portion 21 of the one electrode terminal group BCc and the main line portion 21 of the other electrode terminal group BCc are connected by coupling portions 24 (FIG. 2). One or a plurality of coupling portions 24 is provided depending on the length of the main line portion 21 in the arrangement direction.

In the conductive module 1, the bus bars 10 are housed in respective bus bar housing chambers 41a (FIGS. 2 to 5, 7, and 8) of a main body 41 of the housing member 40, the terminal fitting 30 is placed on the bus bar 10, and the bus bar 10 and the terminal fitting 30 are physically and electrically connected by welding or the like for each bus bar 10. In the conductive module 1, the circuit conductor component 20 is attached to each terminal fitting 30. Therefore, in the conductive module 1, even if it is attempted to dispose the main line portion 21 at the prescribed position by bending each branch portion 22 into the prescribed shape (U-shape described above), the main line portion 21 is returned from the prescribed position toward the original position by the reaction force accompanying the bending of each branch portion 22, and the main line portion 21 rises.

Therefore, the housing member 40 is provided with a main line locking portion 42 that locks the main line portion 21 at the prescribed position in a state where the branch portion 22 is bent into the prescribed shape (FIGS. 3 to 5, 7, and 8). The main line locking portion 42 extends in a direction orthogonal to the arrangement direction, and covers a part of the main line portion 21 in the direction orthogonal to the arrangement direction (that is, the width direction of the main line portion 21) (FIGS. 3 to 5). The main line locking portion 42 is provided at a plurality of locations in the arrangement direction.

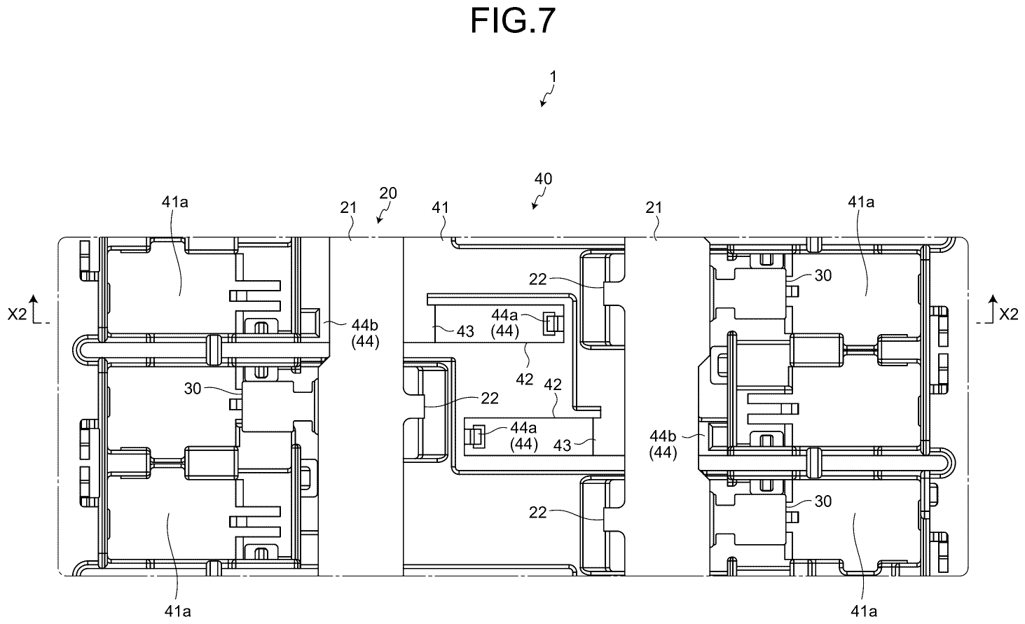

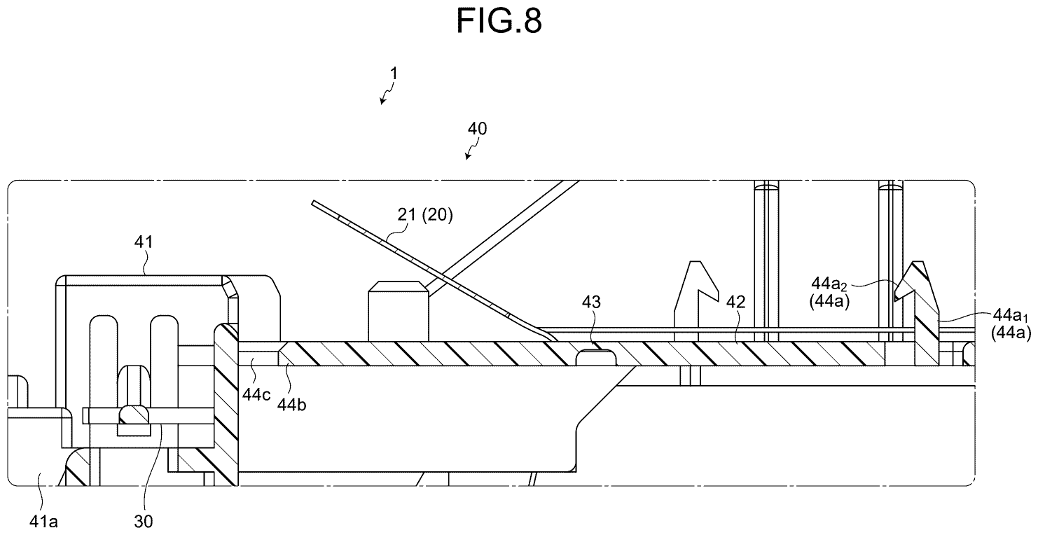

The housing member 40 includes a hinge portion 43 that has a rotation shaft provided on the branch start point side of the main line portion 21 and causes the main line locking portion 42 to rotate between a locking position and a non-locking position of the main line portion 21 (FIGS. 3 to 5, 7, and 8). The hinge portion 43 is provided at one end of the main line locking portion 42. Here, the position of the main line locking portion 42 in FIGS. 7 and 8 is referred to as the non-locking position where the main line portion 21 is not locked by the main line locking portion 42. Note that, in FIG. 7, for convenience of illustration, the main line portion 21 is disposed at the prescribed position.

The main line locking portion 42 is rotated around the axis of the rotation shaft of the hinge portion 43 from the non-locking position toward the locking position. Then, the main line locking portion 42 rotates to the locking position while pressing the main line portion 21 (FIG. 8), which is to try to return to the original position by the reaction force accompanying the bending of each branch portion 22, and maintains the main line portion 21 at the prescribed position at the locking position.

The main line locking portion 42 may be molded as a component different from the housing member 40 and assembled to the housing member 40, or may be formed as a part of the housing member 40. In this example, the main line locking portion 42 is formed as a part of the housing member 40. Therefore, the hinge portion 43 is formed as a living hinge connecting the main body 41 and one end of the main line locking portion 42.

The housing member 40 includes a first engagement portion 44a provided at the other end of the main line locking portion 42, and a second engagement portion 44b that engages the first engagement portion 44a to maintain the locked state of the main line portion 21 at the prescribed position by the main line locking portion 42 (FIGS. 5 and 8). The first engagement portion 44a and the second engagement portion 44b constitute a lock mechanism 44 for maintaining the locked state of the main line portion 21 at the prescribed position by the main line locking portion 42 (FIGS. 3 and 5).

For example, the first engagement portion 44a includes a cantilevered flexible piece portion 44a1 protruding from the other end of the main line locking portion 42 and having flexibility, and a claw portion 44a2 protruding from a free end of the flexible piece portion 44a1 (FIGS. 5 and 8). The second engagement portion 44b is provided at a peripheral edge of a through-hole 44c of the main body 41 (FIGS. 5 and 8). The first engagement portion 44a is inserted into the through-hole 44c. In the first engagement portion 44a, when the main line locking portion 42 is at the locking position, the claw portion 44a2 passing through the through-hole 44c is locked to the second engagement portion 44b at the peripheral edge of the through-hole 44c.

In the main line locking portion 42 at the locking position, the first engagement portion 44a is disposed at a position off one side portion (free end) on the one side portion side (that is, free end side) of the main line portion 21 at the prescribed position (FIG. 5). As a result, the first engagement portion 44a and the second engagement portion 44b cover the one side portion (free end) of the main line portion 21 at the prescribed position from the bus bar 10 side in the engagement state. Therefore, the position of the one side portion (free end) of the main line portion 21 at the prescribed position is regulated by the first engagement portion 44a and the second engagement portion 44b in the engagement state.

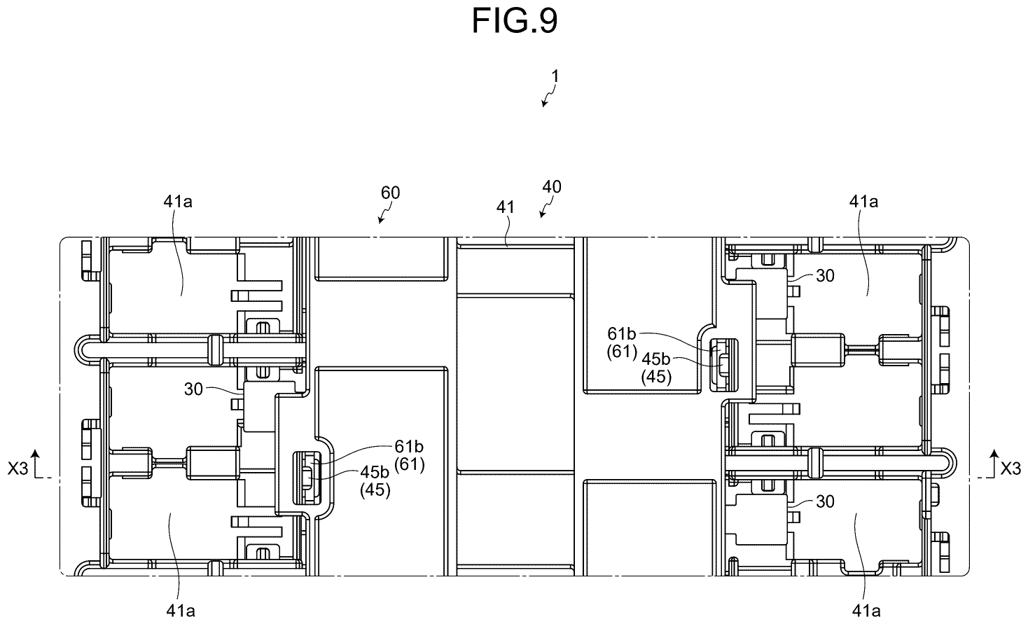

The circuit cover member 60 is assembled to the housing member 40 in a state where the main line portion 21 is held at the prescribed position by the main line locking portion 42 at the locking position, the first engagement portion 44a, and the second engagement portion 44b (FIG. 9). The circuit cover member 60 is a cover member that covers the circuit conductor component 20 together with the main line locking portion 42 at the locking position, and is disposed between the one electrode terminal group BCc and the other electrode terminal group BCc.

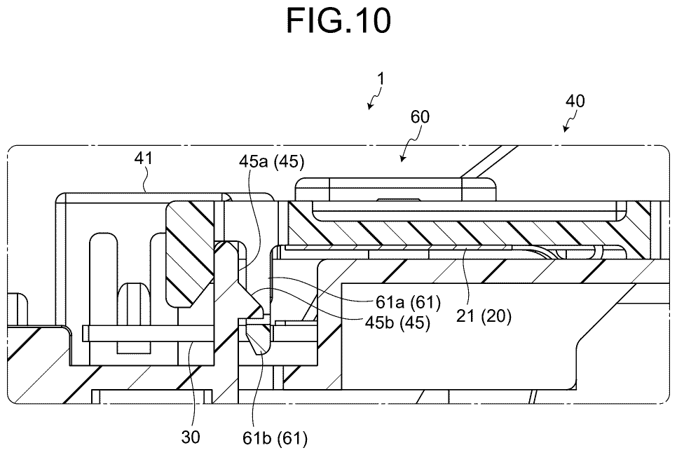

The circuit cover member 60 includes a first cover engagement portion 61 arranged at a position off one side portion (free end) on the one side portion side (free end side) of the main line portion 21 at the prescribed position in an assembly completion state with respect to the housing member 40 (FIGS. 9 and 10). In addition, the housing member 40 includes a second cover engagement portion 45 that engages the first cover engagement portion 61 to maintain the circuit cover member 60 in the assembly completion state with respect to the housing member 40 (FIGS. 9 and 10).

For example, the first cover engagement portion 61 includes a pair of flexible shaft portions 61a having a cantilever shape that is bendable and is disposed to face each other with a space therebetween in the arrangement direction, and a coupling portion 61b coupling free ends of the pair of flexible shaft portions 61a (FIGS. 9 and 10). The second cover engagement portion 45 includes a flexible piece portion 45a having a cantilever shape that is placed vertically from a bottom portion side of the main body 41 of the housing member 40 and has flexibility, and a claw portion 45b protruding from the flexible piece portion 45a (FIGS. 9 and 10). In the second cover engagement portion 45, the claw portion 45b is inserted into the space surrounded by the pair of flexible shaft portions 61a and the coupling portion 61b of the first cover engagement portion 61, and the claw portion 45b is hooked on the coupling portion 61b to maintain the engagement state with the first cover engagement portion 61.

The first cover engagement portion 61 and the second cover engagement portion 45 are brought into the engagement state by assembling the circuit cover member 60 to the housing member 40. Then, the first cover engagement portion 61 and the second cover engagement portion 45 are disposed between the one side portion (free end) of the main line portion 21 at the prescribed position and the bus bar 10 in the engagement state. As described above, the main line portion 21 is held at the prescribed position while suppressing rising with the main line locking portion 42. Then, in the main line portion 21, the position of the one side portion (free end) at the prescribed position is regulated by the first engagement portion 44a and the second engagement portion 44b in the engagement state. Therefore, in the conductive module 1, when the circuit cover member 60 is assembled to the housing member 40, the main line portion 21 does not need to be caught between the first cover engagement portion 61 and the second cover engagement portion 45, so that the circuit cover member 60 can be assembled to the housing member 40 without considering the state of the main line portion 21. As described above, the conductive module 1 of the present embodiment can improve the assembling workability of the circuit cover member 60 with respect to the housing member 40. In addition, in the conductive module 1 of the present embodiment, the cover member 50 is placed from above the circuit cover member 60, and the cover member 50 is assembled to the housing member 40. In the conductive module 1 of the present embodiment, as in the case of assembling the circuit cover member 60, the main line portion 21 is already held at the prescribed position in a state where the rising is suppressed by the main line locking portion 42. Accordingly, in the conductive module 1 of the present embodiment, since the cover member 50 can be assembled to the housing member 40 without considering the state of the main line portion 21, the assembling workability of the cover member 50 with respect to the housing member 40 can be improved.

In the conductive module according to the present embodiment, the main line portion is held at a prescribed position while suppressing rising with the main line locking portion. Therefore, in the conductive module according to the present invention, since the cover member can be assembled to the housing member without considering the state of the main line portion, the assembling workability of the cover member with respect to the housing member can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a plurality of bus bars that electrically connects a plurality of battery cells in a battery module;
a circuit conductor component that includes a circuit conductor for each of the bus bars that electrically connects the bus bar to a battery monitoring unit, the circuit conductor component being formed flat with flexibility;
a housing member that houses the bus bar and the circuit conductor component through an opening; and
a cover member that is assembled to the housing member and closes the opening, and wherein
the circuit conductor component includes a main line portion in which the circuit conductor for each of the bus bars is wired and that is housed at a prescribed position in the housing member, and a branch portion that is obtained by branching the circuit conductor for each of the bus bars from the main line portion and is bent and routed in a prescribed shape within an elastic range between the main line portion at the prescribed position and the bus bar, and
the housing member is provided with a main line locking portion that locks the main line portion at the prescribed position in a state where the branch portion is bent into the prescribed shape.

2. The conductive module according to claim 1, wherein
the branch portion is bent in a U shape from a branch start point side for the branch portion of the main line portion so as to crawl between the main line portion and a bottom portion of the housing member, and
the housing member includes a hinge portion that has a rotation shaft on the branch start point side of the main line portion and causes the main line locking portion to rotate between a locking position and a non-locking position of the main line portion.

3. The conductive module according to claim 2, wherein
the hinge portion is provided at one end of the main line locking portion, and
the housing member includes a first engagement portion provided at an other end of the main line locking portion, and a second engagement portion that engages the first engagement portion to maintain a locked state of the main line portion at the prescribed position by the main line locking portion.

4. The conductive module according to claim 1, wherein
the main line portion is a cantilever having the branch start point side as a fixed end from which the branch portion is branched,
the conductive module further comprising:
a circuit cover member that is assembled to the housing member, is interposed between the circuit conductor component and the cover member, and covers the circuit conductor component together with the main line locking portion at the locking position,
the circuit cover member including a first cover engagement portion arranged at a position off a free end on a free end side of the main line portion at the prescribed position in an assembly completion state with respect to the housing member,
the housing member including a second cover engagement portion that engages the first cover engagement portion to maintain the circuit cover member in the assembly completion state with respect to the housing member.

5. The conductive module according to claim 2, wherein
the main line portion is a cantilever having the branch start point side as a fixed end from which the branch portion is branched,
the conductive module further comprising:
a circuit cover member that is assembled to the housing member, is interposed between the circuit conductor component and the cover member, and covers the circuit conductor component together with the main line locking portion at the locking position,
the circuit cover member including a first cover engagement portion arranged at a position off a free end on a free end side of the main line portion at the prescribed position in an assembly completion state with respect to the housing member,
the housing member including a second cover engagement portion that engages the first cover engagement portion to maintain the circuit cover member in the assembly completion state with respect to the housing member.

6. The conductive module according to claim 3, wherein
the main line portion is a cantilever having the branch start point side as a fixed end from which the branch portion is branched,
the conductive module further comprising:
a circuit cover member that is assembled to the housing member, is interposed between the circuit conductor component and the cover member, and covers the circuit conductor component together with the main line locking portion at the locking position,
the circuit cover member including a first cover engagement portion arranged at a position off a free end on a free end side of the main line portion at the prescribed position in an assembly completion state with respect to the housing member,
the housing member including a second cover engagement portion that engages the first cover engagement portion to maintain the circuit cover member in the assembly completion state with respect to the housing member.
